(19) United States
(12) Patent Application Publication
(10) Pub. No.: US 2012/0161625 A1
(43) Pub. Date: Jun. 28, 2012

(54) LIGHT EMITTING DIODE LIGHTING DEVICE

(76) Inventor: Chia-Ju Lee, Sijhih City (TW)

(21) Appl. No.: 12/975,566

(22) Filed: Dec. 22, 2010

(51) Int. Cl. H01J 13/46; H01K 1/62

(52) U.S. Cl. 315/35; 315/32

(57) ABSTRACT

An LED lighting device is used with a package body. The package body includes at least a connecting part. The LED lighting device includes a shell, an LED module and a controlling circuit board. The LED module is disposed within the shell. The controlling circuit board is disposed within the shell and electrically connected to the LED module. The controlling circuit board includes a connecting unit. The connecting part of the package body and the connecting unit are connected to provide electrical connection between the package body and the controlling circuit board.

### BACKGROUND OF THE INVENTION

1. Field of the Invention

The present invention relates to a light emitting diode (LED) lighting device, and in particular to an LED lighting device with a controlling circuit board which can be inserted with a package body to replace electrical components mounted thereon.

2. Description of Prior Art

A light emitting diode (LED) is a kind of semiconductor device, which exploits the property of direct-bandgap semiconductor material to convert electric energy into light energy efficiently and has the advantages of long service time, high stability and low power consumption.

A general LED lighting device, such as an LED lamp or an LED tube, includes a controlling circuit board and at least an LED, and the LED is electrically connected to the controlling circuit board. The controlling circuit board provides a driving signal to drive the LED and control turn-on and turn-off of the LED.

Generally, the service time of the LED is longer than that of each electrical component which is mounted on the controlling circuit board. Normally, the LED lamp or LED tube is defective due to defecting of each electrical component (such as electrolytic capacitor) mounted on the controlling circuit board. A user not knowing this condition must replace whole LED lamp or LED tube, this causes operation and resource costs.

### SUMMARY OF THE INVENTION

In order to solve the above-mentioned problem, an LED lighting device which can be inserted with a package body into a controlling circuit board is disclosed. Thus, the LED lighting device can effectively reduce operation and resource costs.

Accordingly, the present invention provides an LED lighting device. The LED lighting device is used with a package body. The package body includes at least a connecting part. The LED lighting device includes a shell, an LED module and a controlling circuit board.

The LED module is disposed within the shell. The controlling circuit board is disposed within the shell and electrically connected to the LED module. The controlling circuit board includes a connecting unit. The connecting part of the package body and the connecting unit are connected correspondingly to provide electrical connection between the package body and the controlling circuit board.

The LED lighting device of the present invention has predetermined connecting unit. When electrical components mounted on the controlling circuit board is defective, a user can easily insert a package body which has the replacing electrical component into the connecting unit to replace the defective electrical component, rather than have to replace the whole LED lamp or LED tube entirely, thereby maximizing use of all LEDs and reducing operation and resource costs.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a partial section view of a light emitting diode (LED) lighting device according to a first embodiment of the present invention;

FIG. 2 is a perspective view of the package body and a controlling circuit board;

FIG. 3 is a partial section view of the LED lighting device which having the package body according to the first embodiment;

FIG. 4 is a partial section view of a LED lighting device which having the package body according to the second embodiment.

### DETAILED DESCRIPTION OF THE INVENTION

A preferred embodiment of the present invention will be described with reference to the drawings.

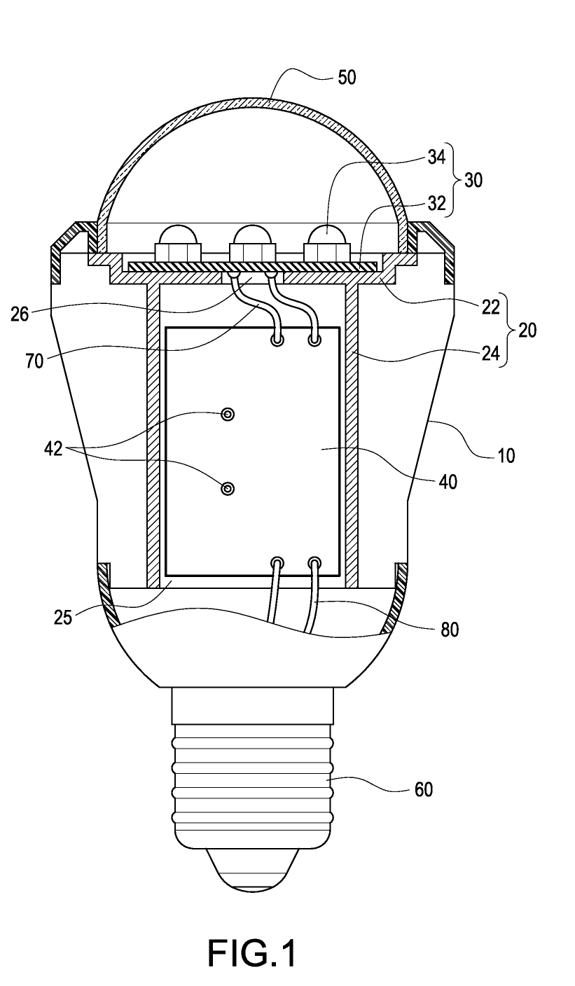

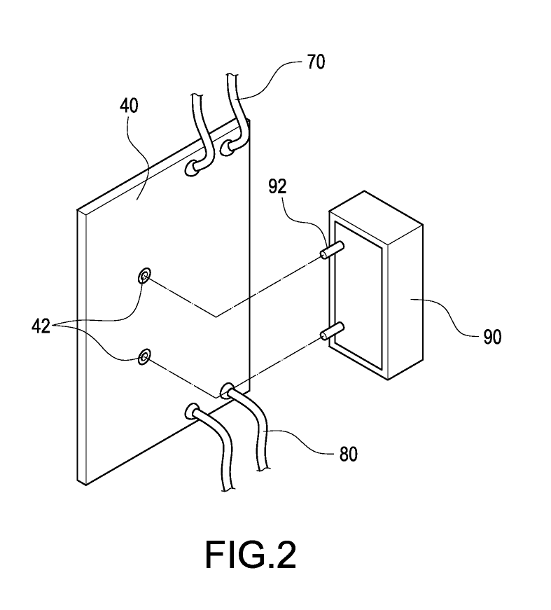

Referenced is made to the FIG. 1 and FIG. 2 which is a partial section view of the light emitting diode (LED) lighting device and a perspective view of the package body and a controlling circuit board according to a first embodiment of the present invention, respectively. In this embodiment, the LED lighting device is an LED lamp and is used with a package body 90. The package body 90 includes a least a connecting part 92. The LED lamp includes a shell 10, a supporting frame 20, an LED module 30, a controlling circuit board 40, a lamp cap 50 and a conductive base 60.

The shell 10 is a poculiform body and made of heat-dissipating material. The support frame 20 is disposed within the shell 10 and includes a bearing part 22 and a supporting part 24 stretched from the bearing part 22. The bearing part 22 and the supporting part 24 collectively define an accommodating space 25. The bearing part 22 is near top end of the shell 10 and the center of the bearing part 22 has a through hole 26.

The LED module 30 is disposed on the bearing part 22 and includes a substrate 32 and a plurality of LEDs 34. The LEDs 34 are mounted on the substrate 32 and electrically connected thereto. In more particularly, the substrate 32 is a printed circuit board and has predetermined circuit layout.

The controlling circuit board 40 is disposed within the accommodating space 25 and includes a connecting unit 42 and a plurality of electrical components (not shown) electrically connected thereto. The connecting unit 42 can be directly formed at the controlling circuit board 40 (such as via) or externally disposed on the controlling circuit board 40 and electrically connected to thereto. The controlling circuit board 40 further includes a first wire assemble 70 and second wire assemble 80. The first wire assemble 70 is passed through the through hole 26 and electrically connected to the LED module 30.

The lamp cap 50 is fixedly fastened to the bearing part 22 and sealed the top end of the shell 10 to enclose the LED module and shield the LEDs 34 from outside hit damage. The lamp cap 50 can be made of glass, plastics, or any suitable material that is light transparent.

The conductive base 60 encloses the bottom end of the shell 10 and is electrically connected to the second wire assemble 80. The LED lighting device with the conductive base 60 can be installed in ordinary lamp fixture (not shown). Electric power provided by the lamp fixture flows through the second wire assemble 80, the controlling circuit board 40, the first wire assemble 70 and the LED module 30 to power and illuminate the LEDs 34.

In the practical operation, the service time of the electrical components mounted on the controlling circuit board 40 is shorter than that of the LEDs 34. Namely, when the controlling circuit board 40 has broken, the LEDs 34 is still fine. For effectively using the LEDs 34, the defected electrical components of the controlling circuit board 40 have to be replaced by the package body 90 which has replacement components.

Referring to FIG. 2 again, the package body 90 includes a connecting part 92 correspondingly set upon the connecting unit 42. The package body 90 can be a section electronic circuit set (namely, the section electronic circuit set contains part of circuits in the controlling circuit board 40) or an electrical component mounted on the controlling circuit board 40 for replacing the damaging components mounted thereon. In more particularly, the electrical component can be an electrolytic capacitor.

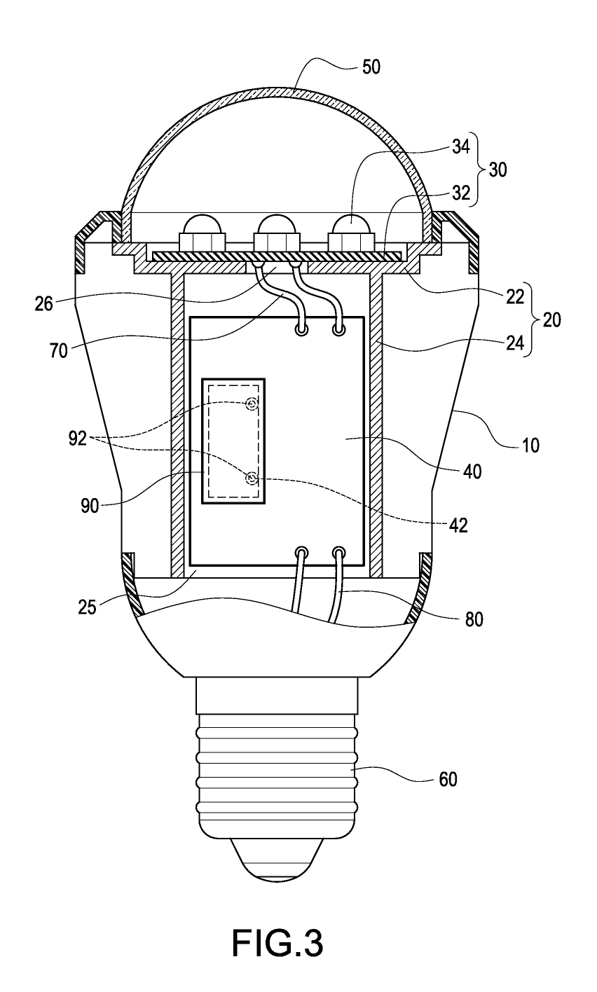

Referenced is made to the FIG. 3 which is a partial section view of the LED lighting device which having the package body according to the first embodiment. The package body 90 is adapted to insert in the connecting unit 42 of the controlling circuit board 40. Electric power provided by the lamp fixture flows through the controlling circuit board 40 by the second wire assemble 80, and then flows to the package body 90, the first wire assemble 70 and the LED module 30 to power and illuminate the LEDs 34.

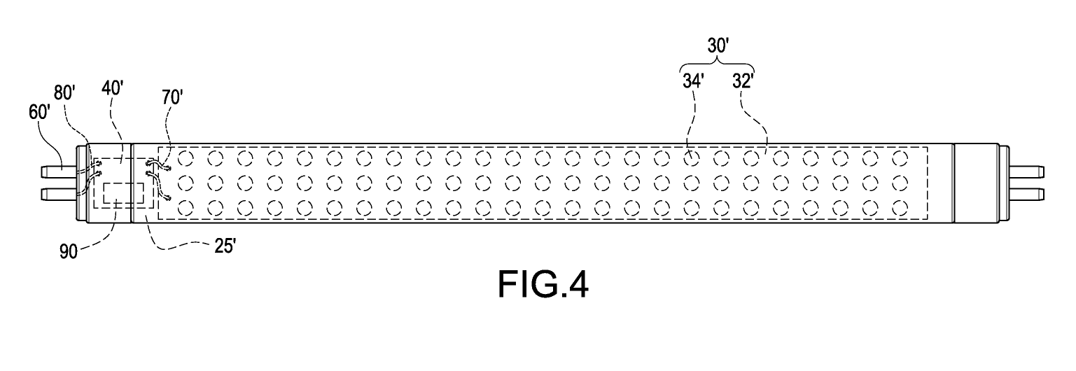

Referenced is made to the FIG. 4 is a partial section-view of an LED lighting device which having the package body according to the second embodiment. In this embodiment, the LED lighting device is an LED tube. The LED tube is used with a package body 90. The package body 90 includes at least a connecting part 92. The LED tube includes a shell 10′, an LED module 30′, a controlling circuit board 40′ and two conductive bases 60′.

The shell 10′ is a light-transmissive tubular body and has an accommodating space 25′. The LED module 30′ is disposed within the accommodating space 25 and includes a substrate 32′ and a plurality of LEDs 34′. The LEDs 34′ are mounted on substrate 32′ and electrically connected thereto. In more particularly, the substrate 30′ is a printed circuit board and had predetermined circuit layout.

The controlling circuit board 40′ is disposed within the volume 25′ and includes a connecting unit 42′ and a plurality of electrical components (not shown) electrically connected thereto. The connecting unit 42′can be directly formed at the controlling circuit board 40′ or externally disposed on the controlling circuit board 40′ and electrically connected to thereof. The controlling circuit board 40′ further includes a first wire assemble 70′ and a second wire assemble 80′, and the first wire assemble 70′ is electrically connected to the LED module 30′.

The conductive bases 60′ respectively enclose two ends of the tubular body and one of the conductive bases 60′ is electrically connected to the second wire assemble 80′. The LED lighting device with the conductive bases 60′ can be installed in ordinary lamp fixture. Electric power provided by the lamp fixture flows through the second wire assemble 80′, the controlling circuit board 40′, the first wire assemble 70′ and the LED module 30′ to power and illuminate the LEDs 34.

In the practical operation, the service time of the electrical components mounted on the controlling circuit board 40′ is shorter than that of the LEDs 34. Namely, when the controlling circuit board 40′ has broken, the LEDs 34′ is still fine. For effectively using the LEDs 34′, the broken components of the controlling circuit board 40′ have to be replaced by the package body 90 which has replacement components. The package body 90 is adapted to insert in the connecting unit 42′ of the controlling circuit board 40. Electric power provided by the lamp fixture flows through the controlling circuit board 40′ by the second wire assemble 80′, and then flows to the package body 90′, the first wire assemble 70′ and the LED module 30′ to power and illuminate the LEDs 34′.

In conclusion, the LED lighting device according to the present invention provides a controlling circuit board, which has predetermined connecting unit. When any electrical component is defective, the LED lighting device allows either electrical component to be replaced by a package body, which has a replacement component. Through electrically connecting the connecting part of the package body and the connecting unit, the replacing component replaces the defective electrical component. As opposite to having to dispose the whole LED lighting device (LED lamp or LED tube), the operation and resource costs are significantly reduced and all LEDs can be optimally used.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An LED lighting device used with a package body, the package body comprising at least a connecting part, the LED lighting device comprising:
a shell;
an LED module disposed within the shell; and
a controlling circuit board disposed within the shell and electrically connected to the LED module, the controlling circuit board comprising a connecting unit;
wherein the connecting part of the package body and the connecting unit to are connected to provide electrical connection between the package body and the controlling circuit board.

2. The LED lighting device in claim 1, further comprising a support frame disposed within the shell, the support frame comprises a bearing part and a supporting part stretched from the bearing part, and the bearing part and the supporting part collectively define an accommodating space.

3. The LED lighting device in claim 2, further comprising a lamp cap fixedly fastened to the bearing part and sealing the LED module.

4. The LED lighting device in claim 3, further comprising a conductive base enclosing one end of the shell which is opposite to the lamp cap, the conductive base electrically connected to the controlling circuit board.

5. The LED lighting device in claim 1, wherein the LED module comprises a substrate and a plurality of LEDs mounted on the substrate.

6. The LED lighting device in claim 1, wherein the shell is a poculiform body and made of heat-dissipating material.

7. The LED lighting device in claim 1, the connecting unit is directly formed at the controlling circuit board or externally disposed on the controlling circuit board and electrically connected to thereto.

8. The LED lighting device in claim 1, wherein the package body is a section electronic circuit set mounted on the controlling circuit board.

9. The LED lighting device in claim 1, wherein the package body is an electrical component mounted on the controlling circuit board.

10. The LED lighting device in claim 9, wherein the electrical component is an electrolytic capacitor.

11. The LED lighting device in claim 1, further comprising two conductive bases enclosing two ends of the shell, wherein one of the conductive bases is electrically connected to the controlling circuit board.

12. The LED lighting device in claim 1, wherein the shell is light-transmissive body.
